(19) United States
(12) Patent Application Publication
(10) Pub. No.: US 2022/0255383 A1
(43) Pub. Date: Aug. 11, 2022

(54) ELECTRIC MACHINE

(71) Applicant: FORD GLOBAL TECHNOLOGIES, LLC, Dearborn, MI (US)

(72) Inventors: Raphael KOCH, Odenthal (DE); Viktor HAEUSER, Burscheid (DE); Maik BRODA, Würselen (DE)

(73) Assignee: FORD GLOBAL TECHNOLOGIES, LLC, Dearborn, MI (US)

(21) Appl. No.: 17/585,947

(22) Filed: Jan. 27, 2022

(30) Foreign Application Priority Data
Feb. 5, 2021 (DE) 102021102753.5

(51) Int. Cl. H02K 3/02; H02K 3/28; B23K 9/00

(52) U.S. Cl. CPC H02K 3/02; B23K 2101/38; B23K 9/0026; H02K 3/28

(57) ABSTRACT

An electric machine includes a conductor structure having at least one metallic conductor element made from at least one of aluminum, copper, and silver having a monocrystalline or columnar crystal structure. The conductor structure may be formed from a plurality of individual flat conductor elements integrally bonded together by welding or soldering to form a winding. The metallic conductor element may be cut from an aluminum, copper, or silver bar having a monocrystalline or columnar crystal structure. A wafer having a plurality of conductor elements may be cut from a bar with the conductor elements separated from the wafer.

### CROSS-REFERENCE TO RELATED APPLICATIONS

This application claims foreign priority benefits under 35 U.S.C. § (a)-(d) to DE 10 2021 102 753.5 filed Feb. 5, 2021 which is hereby incorporated by reference in its entirety.

### TECHNICAL FIELD

This disclosure relates to an electric machine and method for producing a conductor structure for an electric machine that contains copper and/or silver with a monocrystalline or columnar crystal structure.

### BACKGROUND

Electric motors are used in many technical fields. More recently, they have gained increasing significance as an alternative to combustion engines for the propulsion of motor vehicles. The efficacy and energy density of the electric motors have improved progressively over time, and therefore further improvements are becoming increasingly more difficult. Attempts to increase the range of battery-operated electric vehicles, to improve the efficiency of generators, or to achieve further miniaturization of electric motors or generators are approaching generally acknowledged technological limits.

Copper is a raw material typically used in the production of electric motors and other electric machines. The price of copper per metric ton has been subject to significant fluctuations based on various factors including an increasing demand for electronic devices and because copper is a raw material that is traded on the stock exchange. For example, prices have ranged between approximately $1,450/metric ton and approximately $9,900/metric ton over the course of 17 years, generally with a rising trend. Both the price and availability of this raw material are thus difficult to predict. Apart from this, rare earths (such as neodymium, etc.) are currently required in permanent-magnet synchronous motors (PMSM). The price and availability of these materials are also difficult to predict, these being subject, inter alia, to the political outlook of the countries where the mining is performed. To avoid these problems, asynchronous motor (ASM) machines are also used alternatively, which do not require permanent magnets, but have a lower efficiency.

Document CN 108 631 459 B discloses a six-phase permanent-magnet hub motor which is used for an electric vehicle. The motor comprises a stator arrangement, a rotor arrangement, a rotary shaft, a bearing, a housing, covers and a position sensor. The six-phase windings of the stator arrangement have a concentrated single-layer winding structure with separation teeth arranged in-between. The rotor assembly has an internal permanent-magnet rotor, and a carbon-fiber protective sleeve wound around the outer side of the rotor. The stator winding has a monocrystalline copper wire or silver wire, thus reducing the stator loss of the hub motor.

Document CN 209 170 084 U shows a motor with a monocrystalline graphene thin film as an electrical conductor. The motor has a magnetic-field generator, which comprises at least a stator and a rotor, wherein the stator forms a hollow receiving space, in which the rotor is arranged rotatably. The stator and/or the rotor have a monocrystalline graphene conductor track to provide an electrical circuit for the generation of a magnetic field. The motor can be a DC motor, wherein the rotor has an electric magnet which is formed by applying a coating of a monocrystalline graphene thin film as a conductive ribbon wire to a magnetic material or by winding such a thin film around a magnetic material, wherein the stator is a permanent magnet.

Document CN 201 142 264 Y discloses an audio output transformer, having a core and coils of a coil assembly in each stage. In this case, each primary coil has a wound wire formed from monocrystalline copper. The distributed capacitance and the leakage inductance should thus be reduced, a bass-height ratio improved, a greater bandwidth achieved, and a higher audio quality attained.

Document US 7 138 781 B2 discloses a conductor with low resistance using superconductors. The conductor consists of a plurality of around superconductors based on REBa₂Cu₃O₇₋ₓ, in which a RE₂BaCuO₅ phase is dispersed, wherein RE is at least one rare-earth element inclusive of Y. The ground superconductors have a longitudinal direction parallel to a longitudinal direction of the conductor, are arranged in two or more layers, and are electrically connected by normal conductors to an infinite electrical resistor. At 77 K a seemingly specific resistance of the conductor is lower than a specific resistance of copper. Copper, silver and alloys thereof, amongst other things, can be used as normal conductors.

Document RU 2 663 025 C1 discloses a vacuum induction melting and casting facility for producing castings with an oriented and monocrystalline structure. This facility has a melting chamber with a spherical cover, a gateway chamber, a block recoiling and a cooled copper lifting table. The melting chamber has a melting, crucible, a crystallizer, a vacuum system, a mold heating furnace, a vertical movement mechanism for the molds, a vacuum shutter and a mechanism for opening and closing a door. The cooled copper lifting table has cavities for the flow of a coolant.

### SUMMARY

In one or more configurations according to the disclosure, an electric machine includes a conductor structure that has at least one metallic conductor element containing at least one of copper, aluminum, and silver with a monocrystalline or columnar crystal structure. The conductor element may be formed as a wound wire. The conductor structure may include a plurality of integrally bonded conductor elements. The conductor structure may comprise a single conductor element with monocrystalline crystal structure formed as a rotor cage of a squirrel-cage rotor. A monocrystalline conductor element may be produced by cutting a monocrystalline body. In various configurations, a monocrystalline conductor element may be separated from a wafer, which is separated from a monocrystalline body.

It should be noted that the features and measures described individually in the following description can be combined with one another in any technically feasible manner and can provide further embodiments of the invention. The description additionally characterizes and specifies the invention in particular in conjunction with the drawings.

An electric machine according to the disclosure may be an electric motor, but also a generator or transformer. The electric motor can be designed as an asynchronous motor, but also as a synchronous motor, in particular a permanent-magnet synchronous motor. Of course, the electric machine in some applications can also operate sometimes as an electric motor and sometimes as a generator. The electric motor can be, in particular, a drive motor for a vehicle. The vehicle can be a land vehicle, such as a passenger car or heavy goods vehicle, a water vessel, or an aircraft, such as an airplane.

The electric machine has a conductor structure, which in turn has at least one metallic conductor element which contains at least one metal selected from aluminum, copper, and silver. In this context, the term “conductor structure” generally denotes an electrically conductive and in this regard cohesive structure. In some cases, the conductor structure can also consist of a single conductor element, i.e. a conductor element can form the conductor structure. If the conductor structure has a plurality of conductor elements, these are electrically conductively connected to one another. The conductor structure can be, at least in some sections, straight, bent, branched and/or annularly closed. It can extend two-dimensionally to a certain extent in one plane or can be constructed three-dimensionally. These statements in respect of the geometry of the conductor structure can also be transferred to the individual conductor element. In the case of an electric motor or generator, the conductor structure can be part of the rotating part (normally of the rotor) or of the stationary part (stator).

Each conductor element contains at least one metal which is selected from aluminum, copper, and silver. In other words, the conductor element contains aluminum, copper, and/or silver. Aluminum, copper, and/or silver may form the main constituent (in terms of weight) of the conductor element, i.e. the conductor element consists predominantly (i.e. to an extent of more than 50 wt. % up to, and including, 100%) of aluminum, copper, and/or silver, wherein the corresponding proportion normally lies significantly above 50%, for example is at least 80% or at least 90%. For most applications, for example in the case of road vehicles, such as heavy goods vehicles or passenger cars, the conductor clement consists predominantly of copper and/or aluminum. For some applications, however, for example in the case of aircraft, but also in the case of particularly high-quality road vehicles, silver can in some circumstances also form the main constituent. Alloys which contain aluminum, copper, and/or silver are expressly also conceivable.

In accordance with the claimed subject matter, the at least one conductor element has a monocrystalline or columnar crystal structure. In other words, each conductor element can consist of a single crystal with continuously oriented crystal structure without grain boundaries. If the conductor element consists merely of a metal (and possibly negligible contaminations which are caused by the production process), a continuous, uniform crystal structure is provided. Of course, some individual defects in the crystal lattice may be present, however, their amount in the structure referred to in this context as being “monocrystalline” is negligible. In the case of an alloy, the crystal lattice is also oriented identically throughout the conductor element, however, it may have local differences with respect to its composition. Here too, however, in contrast to a conventional polycrystalline structure, there are (practically) no grain boundaries or other lattice defects present.

Alternatively, each conductor element can have a columnar crystal structure, i.e. it is constructed from pillar-like crystals or column-like crystals (or crystallites). These crystallites have an elongate structure and are oriented at least predominantly in one direction, i.e. the orientation of most crystallites deviates, for example, by less than 20° from this direction. In this regard, the columnar crystal structure can be referred to as being oriented in part or for the most part, whereas the monocrystalline crystal structure is fully oriented. To produce the individual conductor element and the conductor structure (if this has a plurality of conductor elements), different possibilities are provided, which will be discussed further below.

By using a conductor element which has an at least partly oriented crystal structure, the specific electrical resistance of the conductor element is reduced on the one hand. In other words, in comparison to a conductor element with a non-oriented (for example globular) crystal structure, with identical dimensions of the conductor element, a lower resistance can be realized and therefore an improved performance of the electric machine can be achieved. Conversely, it would be possible, for example in comparison to a conventional conductor element, to reduce the conductor cross section and thus the overall amount of used metal, wherein the smaller conductor cross section is compensated by the specific electrical resistance, which likewise is lower.

In this way, an electric machine is obtained which achieves a high performance alongside efficient material utilization. The specific electrical resistance in the case of a single crystal is particularly low, and therefore in this regard a conductor structure formed from precisely one conductor element with monocrystalline structure is optimal. However, also with a columnar crystal structure, the specific electrical resistance is lower than with a non-oriented crystal structure, at least in the direction in which the crystallites are predominantly oriented. When a columnar crystal structure is to be given preference over a monocrystalline crystal structure this is dependent on various considerations, for example on the one hand requirements on the electric machine in respect of performance and size or mass, and on the other hand production considerations such as raw material availability and price, for example. The production of a columnar crystal structure is generally simpler and more economical than that of a monocrystalline crystal structure. As is known, in the case of metals there is a correlation between electrical conductivity and thermal conductivity, so that the conductor elements used in accordance with the invention are also characterized by an improved thermal conductivity. It is hereby possible to ensure an efficient dissipation of heat also from regions of the conductor structure where this is almost impossible in the case of conventional manufacture, for example on account of a small conductor cross section or on account of a cold forming process, which can locally reduce both the electrical conductivity and the thermal conductivity. It goes without saying that the improved dissipation of heat likewise contributes to the improvement in the performance of the electric machine and reduces or eliminates localized heating in various regions prone to such phenomena.

Generally, the specific resistance of a pure metal is smaller than that of each of its alloys. In other words, the electrical conductivity of the pure metal is higher, wherein the same is generally also true for the thermal conductivity. For these reasons, it may be desirable for the at least one conductor element to consist of a metal selected from aluminum, copper, and silver. In this regard, this means that the proportion (by weight) of aluminum, copper, or silver is above 98%.

In accordance With one embodiment, at least one conductor element is formed as a wound wire. The wire can have, for example, a circular or circle-like cross section, wherein the diameter is normally less than 1 mm, or a rectangular cross section, wherein the transverse dimensions are normally less than 3 mm. Accordingly, the wire behaves in a flexible manner, and for example can be part of a winding of a stator or rotor. It goes without saying that the wire generally has an insulating coating, for example an insulating varnish. In particular in this embodiment, the conductor element can have a columnar crystal structure, wherein the orientation of the individual crystals or crystallites corresponds to the longitudinal direction of the wire, whereby the resistance in the longitudinal direction is minimized. The wire can, however, also have a monocrystalline structure. The conductor structure normally consists here of a single conductor element. An (endless) wire with columnar or monocrystalline structure can be produced, for example, by means of the Ohno Continuous Casting (OCC) method.

One embodiment provides that the conductor structure has a plurality of conductor elements which are connected in integrally bonded fashion. The conductor elements are prefabricated individually, for example by primary shaping, optionally followed by a forming and/or a cutting. The entire conductor structure is created by connecting the individual conductor elements in integrally bonded fashion to form a cohesive structure. Suitable connection techniques are described further below. It is possible here that a filling material is inserted into the connection regions between two connected conductor elements, which filling material is neither monocrystalline nor columnar. It is also possible that, on account of the connection technique, the monocrystalline or columnar structure otherwise present is locally destroyed in the connection region and instead, for example, a globular structure is present. The corresponding connection region, however, generally accounts for only a small part of the whole conductor structure, and thus does not lead to a significant worsening of the thermal or electrical properties. If necessary, the cross section of the conductor structure in the connection region can be increased in order to compensate for an increase in the specific electrical resistance. In addition, those regions of the conductor structure which, on account of their structure and position, are relatively easily cooled can additionally be selected for the connection regions.

In particular, the conductor structure can be designed as a winding having a plurality of turns, wherein each of the conductor elements connected in integrally bonded fashion is limited to one turn. The individual turns of the winding are arranged in succession and overlapping one another, so that a helical geometry results on the whole. Since each conductor element is limited to one turn, none of the conductor elements overlaps itself. Accordingly, each conductor element can have an approximately two-dimensional structure. A turn can be formed by a single conductor element or by a plurality of conductor elements. For example, a turn can be formed by two conductor elements which are identical, but rotated through 180° relative to one another. In addition. however, other configurations are conceivable, for example a hairpin design or a continuous-winding configuration.

The electric machine can have a squirrel-cage rotor, wherein the conductor structure consists of a single conductor element with monocrystalline crystal structure and is designed as a rotor cage of the squirrel-cage rotor. In other words, in this embodiment the electric machine is normally an asynchronous motor which can be used in some applications as an alternative to a permanent-magnet synchronous motor. The squirrel-cage rotor normally has an (iron) laminated core, which is penetrated by the bars of a rotor cage. These bars extend axially in relation to the rotation axis of the rotor, but normally not parallel to the axial direction. At the axial end face, the bars are connected by a ring and in this way are short-circuited. Whereas in the prior art the bars and the ring are individually prefabricated, assembled and welded, soldered or screwed, in the embodiment discussed here the entire rotor cage is cast, that is to say primarily shaped, in one piece as a single crystal. Alternatively, it would also of course be possible to manufacture the bars and the rings of the rotor cage separately with a crystalline crystal structure and then to connect them to each other, or for example to cast one ring in one piece with the bars as a single crystal, to manufacture the other ring likewise as a single crystal and, following assembly, to weld or to solder these two partial components. In principle, other components as a monocrystalline conductor structure could also consist of a single conductor element; for example, it would be possible for an above-mentioned winding to be primarily shaped in one piece instead of being joined together from individual conductor elements.

A method for producing a conductor structure for an electric machine is furthermore provided, wherein the conductor structure has at least one metallic conductor element, which contains at least one metal selected from aluminum, copper, and silver. The at least one conductor element is produced with a monocrystalline or columnar crystal structure.

The conductor structure can be produced, inter alia, by connecting or joining a plurality of conductor elements in integrally bonded fashion. In particular, the connection can be achieved by soldering or welding of conductor elements. The potential welding techniques include gas welding (autogenous, WIG; MIG; MAG), microplasma welding, electron beam welding, and laser beam welding, for example, which are not intended to be limiting. Welding can be performed here either without additional material or also with (depending on the joint geometry) an additional material, that is to say filling material. Further possible connection techniques are diffusion welding and transient liquid-phase joining. The mentioned connection techniques are suitable in particular for connecting monocrystalline conductor elements, but also for conductor elements with a columnar crystal structure. For example, portions of a wire with columnar structure can also be shaped to form elements for a “hairpin” coil and can be welded after assembly.

Different possibilities exist for producing a monocrystalline conductor element. According to one embodiment a monocrystalline body or bar is produced and at least one conductor element is obtained from this body by cutting. Different methods are possible for producing the monocrystalline body, which at least in some embodiments can also be referred to as a bar, wherein a primary shaping from a melt is normally provided. In the case of the Czochralski method, the single crystal is drawn from the melt, wherein a seed crystal forms the starting point of the crystallization. In the Bridgman-Stockbarger method a melt is lowered little by little in a specially shaped crucible from a zone of higher temperature into a zone of lower temperature, wherein the geometry of the crucible promotes the formation of the single crystal. A further possibility would be the zone melting method. For the most efficient use possible of the monocrystalline body, cutting methods are preferred, in which minimal material is lost, and therefore, for example, laser cutting can be given preference over mechanical, material-removing methods.

In particular, the cutting can be performed in two steps, wherein a wafer is separated from the monocrystalline body and then at least one conductor element is separated from the wafer. The wafer represents a flat disc, which is separated or cut from the monocrystalline body (bar). Multiple wafers can be obtained from one elongate body, which for example can be produced in the Czochralski method, which wafers are then used as a starting point for the next method step. Here, at least one conductor element, normally a plurality of conductor elements, is separated from or cut from the flat wafer. For example, it is hereby easily possible to obtain conductor elements which are then connected and form the turns of a winding. As already explained above, each turn can be formed from a single conductor element. In order to achieve the most efficient possible use of the wafer, it can be advantageous if each turn is formed from at least two conductor elements.

According to another embodiment, at least one conductor element is cast in a casting mold which defines the shape of the conductor element at least in some sections. This allows the precise production of a wide range of different geometries, for example that of the above-mentioned rotor cage. In the case of a suitable method, the casting mold has a first portion, which corresponds to the provided shape of the conductor element, and an adjoining second portion, which is referred to as a selector or, on account of its spiral shape, also as a “pig-tail” selector. The crystallization process starts from the selector in that a polycrystalline structure is initially created, which transitions at the latest at the transition to the first portion into a single crystal. The metal that crystallizes out in the selector can be separated subsequently and melted down again.

### BRIEF DESCRIPTION OF THE DRAWINGS

FIG. 1 shows a schematic sectional illustration of an electric motor according to the disclosure.

FIG. 2 shows a perspective illustration of a monocrystalline body.

FIG. 3 shows a plan view of a wafer cut from a body as shown in FIG. 2.

FIG. 4 shows a perspective illustration of a winding of a stator according to the disclosure.

FIG. 5 shows an illustration of part of a stator corresponding to the illustration of FIG. 4.

FIG. 6 shows a perspective illustration of a squirrel-cage rotor of an electric motor according to the disclosure.

FIG. 7 shows a perspective illustration of a rotor cage of the squirrel-cage rotor from FIG. 6.

FIG. 8 shows a schematic illustration of a device for producing a rotor cage according to the disclosure.

### DETAILED DESCRIPTION

As required, detailed embodiments of the claimed subject matter are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

Like parts are provided with like reference signs in the different figures, and therefore will also generally only be described once.

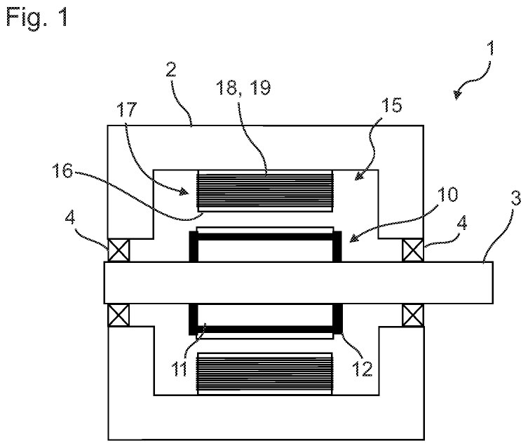

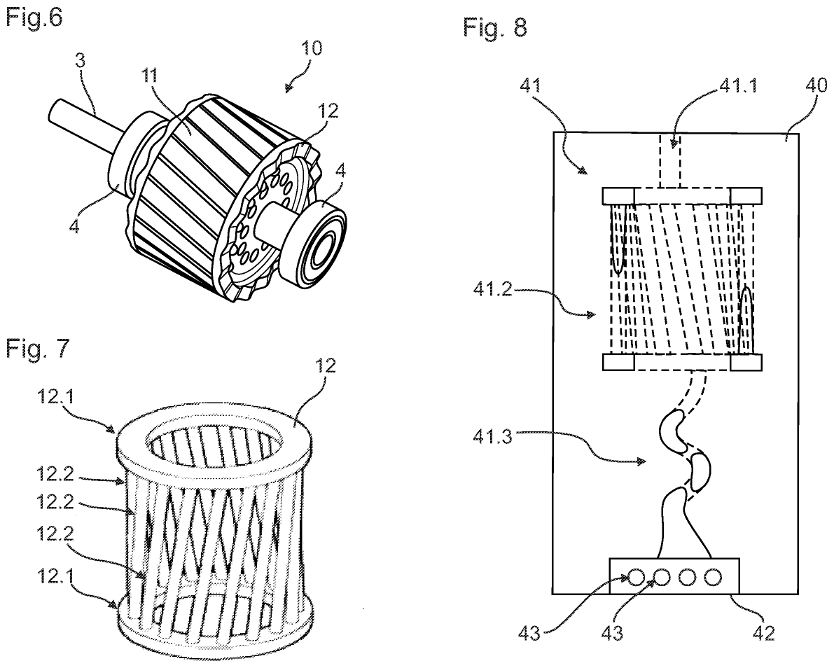

FIG. 1 shows a schematic sectional illustration of a representative electric motor 1 according to this disclosure, more specifically of an asynchronous motor. The electric motor 1 has a stationary housing 2, on which a shaft 3 is rotatably mounted by means of two bearings 4. A rotor or squirrel-cage rotor 10 is connected to the shaft 3. The squirrel-cage rotor has a laminated core 11 and a rotor cage 12, which will be explained in greater detail below with reference to FIGS. 6 and 7. A stationary part or stator 15 is mounted fixedly to the housing 2. The stator 15 has a core 16 formed from an iron alloy, which is surrounded in some sections by a plurality of windings 17.

Each winding 17 is formed by a wire 19, the course of which (similarly to the other components of the electric motor 1) is shown here only schematically. The wire 19 consists in the present case of copper or has a copper content of more than 98%. The crystal structure of the wire 19 is columnar, i.e. it consists of pillar-like crystals or column-like crystals. These are oriented predominantly in the longitudinal direction of the wire 19, whereby the wire 19 has a lower specific resistance than a corresponding wire with a globular crystal structure. It is therefore possible, in comparison to a conventional wire, to use either a thinner wire or to realize, with the same wire cross section, a lower resistance, which has an advantageous effect on the performance of the electric motor 1. In addition, the wire 19 has a lower tendency to heating on account if its low ohmic resistance. Lastly, the lower ohmic resistance is also accompanied by an increased thermal conductivity, and therefore the heat dissipation from any regions of the wire 19 potentially heated to a greater extent is possible more easily. The resistance of the wire 19 can be further reduced in that a wire made of silver or a silver alloy with high silver content is used. The wire 19 can be produced for example by means of the Ohno Continuous Casting (OCC) method. In some circumstances, the production of a wire 19 with monocrystalline structure is also possible here.

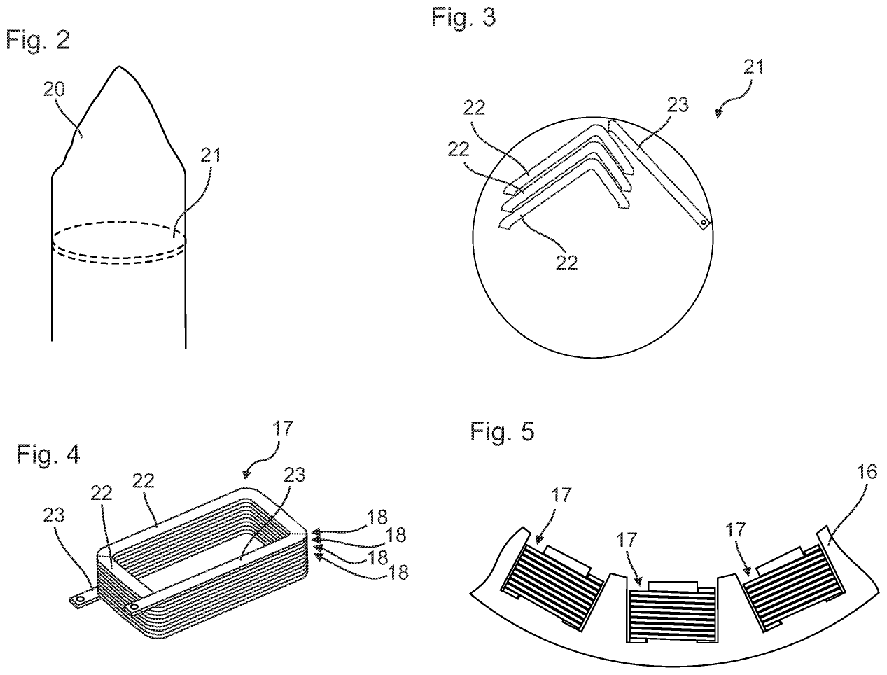

In the embodiment shown in FIG. 1 each winding 17 is manufactured from a one-piece wire 19, which on account of its flexibility, can be wound around the stator core 16. According to an alternative embodiment which is explained with reference to FIGS. 2-5, the windings 17 of the stator 15 can be joined together from prefabricated conductor elements 22, 23. The starting point of manufacture is a monocrystalline bar 20 shown schematically in FIG. 2, which can also be referred to simply as a bar. This can be manufactured for example in the Czochralski method or by means of the Bridgman-Stockbarger method. For most applications, for example in the automotive field, the bar 20 is manufactured from aluminum or copper, whereas for other applications, for example in aircraft construction, a bar 20 can be manufactured from silver.

As shown in FIGS. 2 and 3, a plurality of wafers 21 can be cut from the monocrystalline bar 20. The individual wafer 21 has a disc-like structure and a substantially circular cross section. The thickness of the wafer 21 can be selected according to the desired thickness of the conductor elements 22, 23. FIG. 3 shows a plan view of a wafer 21 with the contours of conductor elements 22, 23 which are cut out from said wafer. The geometry and arrangement of the individual conductor elements 22, 23 has been selected here merely by way of example and in practice can also be selected differently. Three turn elements 22 and one end element 23 are shown. Of course, the number and arrangement of the cut-out conductor elements 22, 23 are normally selected so that the material of the wafer 21 is utilized as optimally as possible.

FIG. 4 shows a winding 17 which has been manufactured from the conductor elements 22, 23. The winding 17 has a plurality of successive turns 18, each of which is composed of two turn elements 22. Here, each turn element 22 is limited to one turn 18, i.e. it does not overlap with itself and therefore can be obtained from the two-dimensional form of the wafer 21 without (significant) shaping. At each end, an end element 23 is connected to a connection element 22. The end elements 23 are used for the electrical connection of the winding 17 within the electric motor 1. The conductor elements 22, 23 can be connected to one another by welding, for example by gas welding, microplasma welding, electron beam welding or laser beam welding. The finished windings 17 can then be inserted into the coil core 16, as shown in FIG. 5.

FIG. 6 is a perspective illustration of the squirrel-cage rotor 10 and of the shaft 3 and the bearing 4. As already mentioned, the squirrel-cage rotor 10 has a laminated core 11 and also a rotor cage 12, which is shown separately in FIG. 7. In this example, the rotor cage 12 is shaped in one piece from copper with a monocrystalline structure. It has a complex three-dimensional structure with apertures. Specifically, two tangentially circumferential rings 12.1 are formed at the axial end faces and are connected to one another by a plurality of bars 12.2. In this example the bars 12.2 run in a straight line, but at an incline to the axial direction. However, other courses are also possible, for example an axial course or a non-straight, for example curved course.

FIG. 8 is a schematic sectional illustration of a device for producing the rotor cage 12 from FIG. 7. A casting mold 40 includes a cavity 41 into which copper in liquid form is poured. In the uppermost region, the cavity 41 has a filling portion 41.1, which is adjoined by a mold portion 41.2. The mold portion 41.2 defines the actual shape of the rotor cage 12. A substantially spiraled selector portion 41.3 is formed below the mold portion 41.2. Below this, the casting mold 40 is adjoined by a copper plate 42 having a plurality of cooling channels 43. Whilst the liquid copper is being poured in through the filling portion 41.1, the casting mold 40 can be heated or temperature-controlled to prevent a premature solidification of the copper. The copper plate 42 is cooled in the intended manner by conducting a coolant (for example water) through the cooling channels 43. This leads to an onset of solidification of the copper in the selector portion 41.3, starting from the bottom and progressing upwardly. The spiral shape of the selector portion 41.3 means that, at least in the upper part of said portion, a monocrystalline structure forms, which then also continues in the mold portion 41.2. Once the copper has fully solidified, the casting mold 40 is removed, which, with the geometry of the cavity 41 shown here, is possible only by destroying the casting mold 40. The parts of the copper body which correspond to the selector portion 41.3 and the filling portion 41.1 are then separated, whereby the rotor cage 12 shown in FIG. 7 is obtained. The separated parts can be melted down and re-used. The method described here can be applied also to a rotor cage 12 which is manufactured from silver.

Although the described representative embodiments relate to an asynchronous motor, similar or other conductor structures with columnar or monocrystalline crystal structure can also be produced for synchronous motors or other electric machines.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

What is claimed is:

1. An electric machine comprising:
a conductor structure having at least one metallic conductor element formed of at least one metal selected from aluminum copper, and silver, the at least one conductor element having a monocrystalline or columnar crystal structure.

2. The electric machine of claim 1 wherein the at least one metallic conductor element comprises a wound wire.

3. The electric machine of claim 1 wherein the at least one metallic conductor element comprises a plurality of individually prefabricated conductor elements integrally bonded together.

4. The electric machine of claim 3 wherein the conductor structure comprises a winding having a plurality of turns and wherein each of the plurality of conductor elements integrally bonded together includes at most one turn.

5. The electric machine of claim 1 wherein the electric machine includes a squirrel-cage rotor and wherein the conductor structure comprises a single conductor element having a monocrystalline crystal structure formed as a rotor cage of the squirrel-cage rotor.

6. The electric machine of claim 1 wherein the at least one metallic conductor element comprises a plurality of conductor elements integrally welded together.

7. The electric machine of claim 1 wherein the monocrystalline or columnar crystal structure is oriented in a longitudinal direction of the conductor element.

8. The electric machine of claim 1 further comprising a stator having a stator core formed from an iron alloy, wherein the conductor structure and the, at least one conductor element comprises copper wire windings wound around at least a port of the stator core, and wherein the monocrystalline or columnar crystal structure is oriented in a longitudinal direction of the copper wire windings.

9. The electric machine of claim 1 wherein the conductor structure comprises a winding formed from individual conductor elements, the winding having a plurality of successive turns each of which includes two turn elements corresponding to two of the individual conductor elements, wherein each turn element is limited to one turn and does not overlap with itself.

10. A method for making a conductor structure of an electric machine, comprising:
forming at least one conductor element from at least one metal selected from aluminum, copper, and silver having a monocrystalline or columnar crystal structures; and
forming the at least one conductor element into the conductor structure.

11. The method of claim 10 wherein forming the at least one conductor element comprises cutting the at least one conductor element from an aluminum, copper, or silver bar.

12. The method of claim 11 wherein cutting the at least one conductor element comprises cutting a wafer from the aluminum, copper, or silver bar, and separating the at least one conductor element from the wafer.

13. The method of claim 12 wherein separating the at least one conductor element comprises cutting the at least one conductor element from the wafer.

14. The method of claim 11 wherein forming at least one conductor element comprises forming a plurality of conductor elements each having not more than one bend, and bonding the conductor elements together to form a winding.

15. The method of claim 14 wherein bonding the conductor elements comprises welding the conductor elements together.

16. The method of claim 10 wherein forming the at least one conductor element comprises casting the at least one conductor element in a casting mold.

17. An electric machine comprising:
a conductor structure having a plurality of conductor elements individually formed from copper having a monocrystalline or columnar crystal structure integrally bonded together.

18. The electric machine of claim 17 wherein the conductor structure comprises a stator winding.

19. The electric machine of claim 18 wherein the conductor elements are welded together.

20. The electric machine of claim 19 wherein each of the conductor elements includes at most one turn.
